(19) United States
(12) Patent Application Publication
(10) Pub. No.: US 2026/0109348 A1
(43) Pub. Date: Apr. 23, 2026

(54) VEHICULAR DRIVING ASSIST SYSTEM WITH ENHANCED THREAT ASSESSMENT

(71) Applicant: Magna Electronics Inc., Auburn Hills, MI (US)

(72) Inventors: Nikunj Vinubhai Kumbhani, Troy, MI (US); Drumit Bharatkumar Modi, Bloomfield Hills, MI (US); Akshay Garg, Troy, MI (US); Kirti Hiranand Balani, Maharashtra (IN)

(21) Appl. No.: 19/359,973

(22) Filed: Oct. 16, 2025

Related U.S. Application Data
(60) Provisional application No. 63/708,937, filed on Oct. 18, 2024.

(51) Int. Cl. B60W 30/095; B60R 11/00; B60R 11/04; B60W 30/09; G06V 20/56

(52) U.S. Cl. CPC B60W 30/0953; B60R 11/04; B60W 30/09; G06V 20/56; B60R 2011/0026; B60W 2420/403; B60W 2420/408; B60W 2510/20; B60W 2520/14; B60W 2710/18

(57) ABSTRACT

A vehicular driving assist system includes a plurality of sensors disposed at a vehicle. The vehicular driving assist system, via processing of captured sensor data, is operable to detect presence of an object. The vehicular driving assist system determines a current overlap between the detected object and the predicted path of travel of the equipped vehicle based at least in part on a current position of the detected object. The vehicular driving assist system determines a predicted overlap between a predicted position of the detected object and a predicted path of travel of the equipped vehicle based at least in part on a lateral velocity of the detected object. The vehicular driving assist system determines that the detected object is a threat based at least in part on (i) the determined current overlap and (ii) the predicted overlap.

### CROSS REFERENCE TO RELATED APPLICATION

The present application claims the filing benefits of U.S. provisional application Ser. No. 63/708,937, filed Oct. 18, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or sensing system or vision system or imaging system for a vehicle utilizes a plurality of sensors disposed at the vehicle equipped with the driving assist system and sensing exterior of the equipped vehicle, the plurality of sensors are operable to capture sensor data. The vehicular driving assist system includes an electronic control unit (ECU) including electronic circuitry and associated software, wherein sensor data captured by the plurality of sensors is transferred to the ECU. The electronic circuitry of the ECU includes a data processor for processing sensor data captured by individual sensors of the plurality of sensors and transferred to the ECU. The vehicular driving assist system, via processing at the ECU of captured sensor data, is operable to detect presence of an object exterior of the equipped vehicle. The vehicular driving assist system determines a current overlap between the detected object and the predicted path of travel of the equipped vehicle based at least in part on the current position of the detected object. The vehicular driving assist system determines a predicted overlap between a predicted position of the detected object and a predicted path of travel of the equipped vehicle based at least in part on a lateral velocity of the detected object. The driving assist system determines that the detected object is a threat based at least in part on (i) the determined current overlap between the detected object and the predicted path of travel of the equipped vehicle and (ii) the predicted overlap between the detected object and the predicted path of travel of the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system; and

FIG. 2 is a plan view of an overlap calculation scenario with a lead vehicle and a vehicle with a vision system.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted trajectory of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

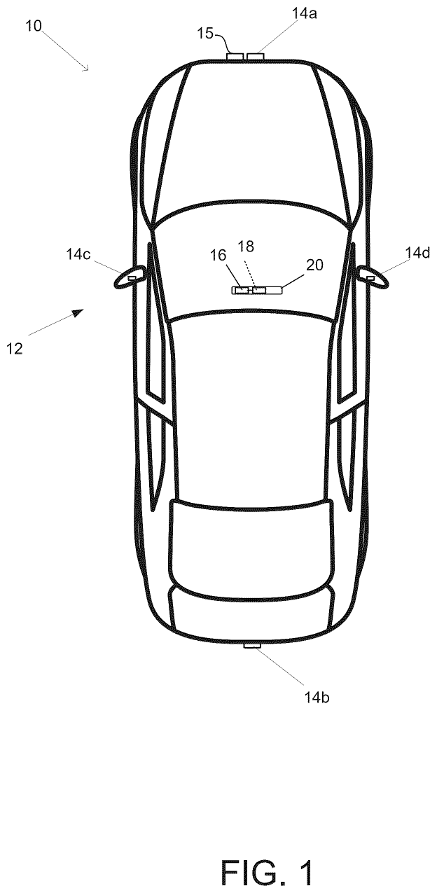

Referring now to the drawings and the illustrative embodiments depicted therein, an equipped vehicle 10 (i.e., ego vehicle or host vehicle) includes an imaging system or vision system 12 that includes at least one exterior viewing imaging sensor or camera, such as a forward camera or forward viewing imaging sensor or camera 14a and the system may optionally include multiple exterior viewing imaging sensors or cameras, such as a rear backup camera 14b or rearward viewing imaging sensor or camera, and a sideward/rearward viewing camera 14c, 14d at respective sides of the vehicle. The camera(s) captures images exterior of the equipped vehicle 10, with the camera having a lens for focusing images at or onto an imaging array or imaging plane or imager of the camera (FIG. 1). Optionally, a forward viewing camera may be disposed at the windshield of the equipped vehicle 10 and view through the windshield and forward of the equipped vehicle 10, such as for a machine vision system (such as for traffic sign recognition, headlamp control, pedestrian detection, collision avoidance, lane marker detection and/or the like). The vision system 12 may include other sensors, such as one or more radar sensors 15. The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the equipped vehicle 10 (although shown in FIG. 1 as being part of or incorporated in or at an interior rearview mirror assembly 20 of the equipped vehicle 10, the control and/or the display device may be disposed elsewhere at or in the equipped vehicle 10). The data transfer or signal communication from the camera to the ECU may comprise any suitable data or communication link, such as a vehicle network bus or the like of the equipped vehicle 10.

A fusion system may integrate data from multiple sensors, such as cameras and radars, to provide object and lane information for use by one or more advanced driver-assistance systems (ADAS). By combining data from different sensor types, the fusion system may generate more robust data regarding the surroundings of the equipped vehicle 10 . . . . By leveraging the strengths of different sensor types, the fusion system can determine more accurate and robust data and/or information (e.g., object information) regarding the vehicle's surroundings for use by systems of the vehicle and/or a driver of the vehicle.

The object information gathered by the fusion system may be used for the longitudinal control of the vehicle. For instance, safety features, such as autonomous emergency braking (AEB), use object information to detect potential collisions and automatically apply brakes of the vehicle to prevent or mitigate accidents. In addition to safety features, the fusion system may support comfort features like adaptive cruise control (ACC). ACC utilizes object information to maintain the vehicle at a set speed while automatically adjusting the vehicle's speed to keep a safe distance from other vehicles, such as vehicles ahead of the equipped vehicle.

Implementations herein include a system that enables longitudinal control of a vehicle equipped with both camera and radar systems, such as for the purpose of AEB. The system provides accurate and timely determination of threats posed by various road users, particularly pedestrians and other vulnerable road users (VRUs), as well as other vehicles in car-to-car (C2C) scenarios. That is, the system provides accurate and timely determination of objects that are likely to collide with the equipped vehicle. VRUs encompass pedestrians and cyclists, but the term may also extend to motorcyclists, road workers, and the like, who are considered pedestrians in this context. The system prioritizes objects based on which objects pose the highest threat to the equipped vehicle, increasing speed, efficiency, and effectiveness of responses to the objects by system or features of the equipped vehicle, such as ADAS, AEB, or ACC.

The system may include a threat assessment module that determines an overlap score and/or a threat level and/or a trust level for all objects (i.e., obstacles) forward and within a threshold distance of the vehicle equipped with the system. Additionally or alternatively, the threat assessment module determines an overlap score for all objects detected by the fusion system. The overlap score/threat level/trust level may indicate a likelihood or probability that the object will collide with the equipped vehicle (i.e., whether the object poses a threat to the vehicle). More generally, threat assessment for an ADAS with AEB may include evaluating potential risks that could compromise the ADAS's functionality and safety. The threat assessment module enables the ADAS to accurately detect and respond to obstacles, thereby enhancing overall vehicle safety and reducing the likelihood of collisions.

The system may implement a combination of several different threat determination techniques. For example, the system may utilize time to collision (TTC), object lateral distances relative to the equipped vehicle, and object longitudinal distances relative to the equipped vehicle. TTC is a metric used to determine the time remaining before a collision between the equipped vehicle and an object occurs, provided that the current speed and predicted trajectory of the equipped vehicle and the object remain unchanged. TTC and object lateral/longitudinal distances may be monitored instantaneously or predicted. Optionally, the threat assessment module uses a combination of prediction and instantaneous monitoring. In one example, the system may determine a first TTC of an object and the equipped vehicle based on instantaneously monitored sensor data, and the system may determine a second TTC of the object and the equipped vehicle based on the predicted trajectory of the equipped vehicle. By determining the first TTC and the second TTC, the system may assess potential overlaps (i.e., a current overlap and a predicted overlap) between the object and the equipped vehicle at both TTCs and determine an overlap score for the object based on a worst case overlap between the potential overlaps.

Threats may be any objects that are in adjacent lanes and/or are approaching the lane occupied by the equipped vehicle (i.e., the host lane), objects that are crossing the lane occupied by the equipped vehicle (e.g., at an intersection), objects oncoming toward the equipped vehicle, etc. The threat assessment module determines whether a target object or vehicle (i.e., a vehicle other than the equipped vehicle) poses a threat to the equipped vehicle using multiple factors. For example, whether the target object from the fusion system is a threat to the equipped vehicle may be determined based on factors that include current and predicted overlap of the target object with the equipped vehicle, target object presence/position, and/or the confidence of these factors as reflected in an overlap score (or a trust level) assigned to the target object by the threat assessment module. These factors are further described below.

The system may cause an AEB feature or system to generate a braking deceleration command based on fusion system signals from, e.g., one or more cameras and one or more radar sensors. The threat assessment module uses metrics to confirm threats from all potential threats identified by the fusion system based on the amount of deceleration required by the equipped vehicle to achieve collision avoidance with each of the identified potential threats.

The metrics may include determining a curvature of a predicted trajectory of the equipped vehicle based on a current yaw rate of the equipped vehicle. The curvature determination based on yaw rate uses rotational mechanics to determine the curvature of the trajectory of the equipped vehicle when the equipped vehicle is traveling at a speed that is greater than a threshold speed (e.g., greater than 20 miles per hour (mph), 30 mph, 40 mph, or 50 mph, etc.). Determining curvature of the trajectory of the vehicle based on yaw rate may be more accurate above the threshold speed than determining curvature of the trajectory of the vehicle based on yaw rate below the threshold speed, as yaw rate determinations and/or measurements generally increase in reliability as speed of the vehicle increases. The rotational mechanics may be based on vehicle velocity and/or vehicle speed, steering system position (e.g., steering angle of front wheels of the vehicle and/or steering angle of a steering wheel of the vehicle) lateral acceleration of the equipped vehicle, and other data from the equipped vehicle to determine the curvature of the trajectory of the equipped vehicle.

The metrics may also include determining a curvature of the predicted trajectory of the equipped vehicle based on steering position. For example, the system may determine curvature of the trajectory of the equipped vehicle based on steering position when the vehicle is traveling at a speed that is less than the threshold speed (e.g., less than 20 mph, 30 mph, 40 mph, or 50 mph, etc.). The curvature determination based steering angle may be more reliable below the threshold speed than determining curvature of the vehicle based on steering angle above the threshold speed.

The determined curvature, when based on steering position, uses a steering position of a steering system of the equipped vehicle to determine the curvature of the trajectory of the equipped vehicle when the equipped vehicle is traveling below the threshold speed. The threat assessment module may determine the steering position based on a measured position of a steering wheel of the equipped vehicle or based on a measured steering angle of the vehicle's steering system (e.g., based on a steering angle of front wheels of the vehicle).

The metrics may also include one or more overlap score determinations or overlap levels or trust levels based on a predicted overlap and/or a current overlap. A current overlap between the detected object and a predicted path of travel of the equipped vehicle may be based at least in part on a current position of the detected object. A predicted overlap between a predicted position of the detected object and the predicted path of travel of the equipped vehicle may be based at least in part on a lateral velocity of the detected object. The threat assessment module determines an overlap score from a plurality of overlap scores for each of the objects identified in the object information provided by the fusion system. For example, the system assigns one of six overlap scores to each object. The overlap score assigned to the object represents a determined overlap between the object and the equipped vehicle based on current overlap measurements and/or the predicted trajectory of the equipped vehicle. The overlap score may refer to a likelihood or probability that the equipped vehicle and the object will collide. Optionally, the threat assessment module may assign no overlap score to an object when the object is moving away from the equipped vehicle in the lateral direction. By assigning no overlap score to the object, the threat assessment module may filter out the object (i.e., cease to provide information regarding the object to ADAS systems of the equipped vehicle) so as to preserve computational resources of the ADAS systems and/or the threat assessment module (i.e., to reduce noise).

For example, if an object identified in the object information provided by the fusion system (i.e., a detected object) is moving laterally into the determined trajectory of the equipped vehicle, the threat assessment module may assign a first overlap score (e.g., an overlap score 1 or overlap level 1 or trust level 1) to the detected object. By assigning the first overlap score to the detected object, the threat assessment module has prioritized the detected object as a higher threat to the equipped vehicle than, e.g., objects moving laterally away from the determined trajectory of the equipped vehicle. In this way, the overlap score helps eliminate (i.e., filter) objects that are not a threat because they are moving laterally away from the equipped vehicle.

If the fusion system determines that a detected object overlaps the lane occupied by the equipped vehicle, or the host lane, (i.e., an overlap amount) by at least a threshold amount (e.g., the detected object occupies 10%, 25%, or 50%, etc. of the lane), the threat assessment module may assign a second overlap score (e.g., an overlap score 2) to the detected object. In some examples, the lane threshold amount may have a value within the range of 10% to 75% overlap with the host lane. By assigning the second overlap score to the detected object, the threat assessment module prioritizes the detected object as a higher threat to the equipped vehicle than, e.g., objects that are outside of the lane or that overlap the lane by less than the lane threshold amount.

If the fusion system determines that a detected object overlaps a predicted trajectory of the equipped vehicle by at least a threshold amount (e.g., the detected object occupies 10%, 25%, or 50%, etc. of the predicted path), the threat assessment module may assign a third overlap score (e.g., an overlap score 3) to the detected object. In some examples, the predicted trajectory threshold amount may have a value within the range of 10% to 75% overlap with the predicted trajectory. Optionally, if lane markings are not visible on the road along which the equipped vehicle is traveling, and the detected object has non-zero overlap with the predicted trajectory of the equipped vehicle that is less than the predicted trajectory threshold amount, the threat assessment module may assign the third overlap score to the detected object. By assigning the third overlap score to the detected object, the threat assessment module prioritizes the detected object as a higher threat to the equipped vehicle than, e.g., objects that are outside of the predicted trajectory or that overlap the predicted trajectory by less than the predicted trajectory threshold amount.

If the fusion system determines that a detected object both overlaps the lane occupied by the equipped vehicle by at least the lane threshold amount (e.g., the detected object occupies 10%, 25%, or 50%, etc. of the lane) and overlaps a predicted trajectory of the equipped vehicle by the predicted trajectory threshold amount (e.g., the detected object occupies 10%, 25%, or 50%, etc. of the predicted path), the threat assessment module may assign a fourth overlap score (e.g., an overlap score 4) to the detected object. Optionally, if lane markings are not visible on the road along which the equipped vehicle is traveling, and the detected object overlaps the predicted trajectory of the equipped vehicle by the predicted trajectory threshold amount, the threat assessment module may assign the fourth overlap score to the detected object. By assigning the fourth overlap score to the detected object, the threat assessment module prioritizes the detected object as a higher threat to the equipped vehicle than, e.g., objects that are outside of the predicted trajectory or that overlap the predicted trajectory by less than the predicted trajectory threshold amount. That is, by assigning the fourth overlap score to the detected object, the threat assessment module prioritizes the detected object as a higher threat to the equipped vehicle than, e.g., objects that overlap the host lane by the host lane threshold amount but do not overlap the predicted trajectory by the predicted trajectory threshold amount.

If the fusion system determines that a detected object overlaps a predicted adjacent lane left of the predicted trajectory of the equipped vehicle by at least a threshold amount (e.g., the detected object occupies 10%, 25%, or 50%, etc. of the predicted adjacent left lane), the threat assessment module may assign a fifth overlap score (e.g., an overlap score 5) to the detected object. In some examples, the adjacent left lane threshold amount may have a value within the range of 10% to 75% overlap with the predicted adjacent lane left of the predicted trajectory of the equipped vehicle. By assigning the fifth overlap score to the detected object, the threat assessment module prioritizes the detected object as a higher threat to the equipped vehicle than, e.g., objects that are outside of the predicted adjacent left lane or that overlap the predicted adjacent left lane by less than the adjacent left lane threshold amount.

If the fusion system determines that a detected object overlaps a predicted adjacent lane right of the predicted trajectory of the equipped vehicle 10 by at least a threshold amount (e.g., the detected object occupies 10%, 25%, or 50%, etc. of the predicted adjacent right lane), the threat assessment module may assign a sixth overlap score (e.g., an overlap score 6) to the detected object. In some examples, the adjacent right lane threshold amount may have a value within the range of 10% to 75% overlap with the predicted adjacent lane right of the predicted trajectory of the equipped vehicle. By assigning the sixth overlap score to the detected object, the threat assessment module prioritizes the detected object as a higher threat to the equipped vehicle than, e.g., objects that are outside of the predicted adjacent right lane or that overlap the predicted adjacent right lane by less than the adjacent right lane threshold amount.

Each threshold amount and value for each of the overlap scores discussed above may be a different threshold. Optionally, at least a portion of the thresholds may be the same. Each threshold may be configured based on the specific parameters of the equipped vehicle (e.g., speed, size, weight, etc.), current conditions (e.g., weather conditions, ambient light levels, etc.), occupant preferences, etc. The current conditions may be determined by sensors of the equipped vehicle, received via internet and/or Bluetooth connection and/or radio, etc.

The threat assessment module may prioritize a first detected object with a first overlap score as a greater threat to the equipped vehicle than a second detected object with a second overlap score. Optionally, the threat assessment module may assign overlap scores to objects based at least in part on determining the type of object, such as determining that the object is a road user, a VRU, a pedestrian, or a vehicle. By determining the type of object, the threat assessment module may assess various scenarios, such as whether a pedestrian is crossing, or whether construction workers are present. In some examples, the type of object may be determined by the fusion system and/or another system of the vehicle, and the threat assessment module may receive the type of object as input.

Through assigning a detected object with an overlap score, the threat assessment module eliminates system noise by prioritizing the detected object as a greater threat to the equipped vehicle over other objects detected by the fusion system. Similarly, through assigning a detected object with a high overlap score, the threat assessment module prioritizes the detected object as a greater threat to the equipped vehicle than other objects to which the threat assessment module assigned a lower overlap score. The prioritization of detected objects improves the speed, efficiency, and effectiveness of responses by systems or features on the equipped vehicle, such as the vision system 12, ADAS, AEB, or ACC. For example, the system may disregard or deprioritize objects that are not assigned an overlap score or level, as these objects may be deemed sufficiently unlikely to be a threat.

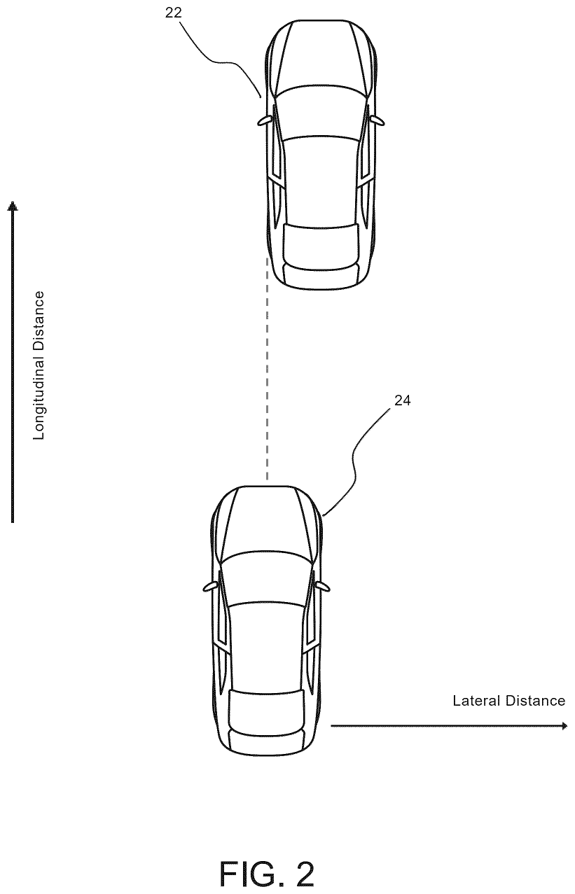

FIG. 2 illustrates an example overlap score or level determination scenario. Here, a lead vehicle 22 represents an example target vehicle and/or detected object, and a following vehicle 24 represents a reference point of a vehicle equipped with the system described herein. In this scenario, the system (which may include or be a part of one or more advanced driving assistance systems, such as an AEB feature, an ACC feature, etc.) calculates the overlap of the lead vehicle 22 with a curvature of the equipped vehicle 24.

As used herein, the variable C₀ represents a curvature of the trajectory of the equipped vehicle, determined from the yaw rate and/or steering position and/or speed of the equipped vehicle. The variable y represents a lateral distance of the object (e.g., the lead vehicle 22) relative to the equipped vehicle, based on input the system receives from the fusion system. The variable x represents the longitudinal distance of the object relative to the equipped vehicle, based on input the system receives from the fusion system. The variable v_{y} represents the lateral velocity of the object relative to the equipped vehicle, based on input the system received from the fusion system. The variable vₓ represents the longitudinal velocity of the object relative to the equipped vehicle, based on input the system receives from the fusion system.

The variable W_{Ego} refers to the width of the equipped vehicle. The variable W_{obj} refers to the width of the object, based on input the system receives from the fusion system. The variable TTC represents the time to collision with the object. The variable al represents the nearest left edge (which may be internally computed), and a_{R} represents the nearest right edge (which may be internally computed).

The system may determine the predicted lateral shift of the equipped vehicle from the equipped vehicle's current position to when the equipped vehicle reaches the object sensed by the fusion system, represented by Equation (1) below. The system further determines the predicted lateral position of the left extreme of the equipped vehicle (L_{EgoPred.}), represented by Equation (2), and the predicted lateral position of the right extreme of the equipped vehicle (R_{EgoPred.}), represented by Equation (3):

$${Y}_{EgoPred .} = \frac{1}{2} {C}_{0} {x}^{2} \qquad ( 1 )$$

$${L}_{EgoPred .} = {Y}_{EgoPred .} + \frac{1}{2} {W}_{Ego} \qquad ( 2 )$$

$${R}_{EgoPred .} = {Y}_{EgoPred .} - \frac{1}{2} {W}_{Ego} \qquad ( 3 )$$

The system may determine a predicted lateral position of the object after time (Δt), represented by Equation (4):

$$\begin{matrix}Δ t = minimum ( TTC , 1 ) \\ {Y}_{ObjPred .} = y + {v}_{y} Δ t\end{matrix} \qquad ( 4 )$$

Then the system determines the predicted left extreme of the object (L_{ObjPred.}), represented by Equation (5), the predicted right extreme of the object (R_{ObjPred.}), represented by Equation (6), the current left extreme of the object (L_{ObjCurrent}), represented by Equation (7), and the current right extreme of the object (R_{ObjCurrent}), represented by equation (8):

$${L}_{ObjPred .} = {Y}_{ObjPred .} + \frac{1}{2} {W}_{Obj} \qquad ( 5 )$$

$${R}_{ObjPred .} = {Y}_{ObjPred .} - \frac{1}{2} {W}_{Obj} \qquad ( 6 )$$

$${L}_{ObjCurrent} = y + \frac{1}{2} {W}_{Obj} \qquad ( 7 )$$

$${R}_{ObjCurrent} = y - \frac{1}{2} {W}_{Obj} \qquad ( 8 )$$

Following the above determinations, the system may determine the current overlap amount and the predicted overlap amount. The current overlap amount is represented by Equation (9):

$$\begin{matrix}{a}_{L} = minimum ( {L}_{EgoPred .} , {L}_{ObjCurrent} ) \\ {a}_{R} = maximum ( {R}_{EgoPred .} , {R}_{ObjCurrent} ) \\ Overlap = \frac{{a}_{L} - {a}_{R}}{minimum ( {W}_{Ego} , {W}_{Obj} )}\end{matrix} \qquad ( 9 )$$

The predicted overlap amount is represented by Equation (10):

$$\begin{matrix}{a}_{L} = minimum ( {L}_{EgoPred .} , {L}_{ObjPred .} ) \\ {a}_{R} = maximum ( {R}_{EgoPred .} , {R}_{ObjPred .} ) \\ {Overlap}_{Pred .} = \frac{{a}_{L} - {a}_{R}}{minimum ( {W}_{Ego} , {W}_{Obj} )}\end{matrix} \qquad ( 10 )$$

The system may determine an overlap score for the object based on the determined current overlap amount and the predicted overlap amount.

Thus, the vehicle vision system and/or driving assist system is designed to enhance vehicle safety and maneuverability by processing captured exterior images around the vehicle. This system integrates multiple sensors, including cameras and radar, to provide comprehensive object and lane information. A fusion system combines data from various sensors to improve the accuracy and reliability of advanced driver-assistance systems (ADAS), supporting features such as AEB and ACC. A threat assessment module within the system evaluates potential threats by calculating overlap scores or threat levels for objects along a predicted trajectory and/or a host lane of the vehicle, using metrics such as time to collision, lateral object distances, and/or longitudinal object distances. This module prioritizes and/or filters threats based on factors like object position and predicted trajectory overlap, enabling timely and effective responses to potential collisions by reducing or eliminating object “noise” (i.e., by quickly filtering out objects that are not threats). The system's ability to determine a curvature of the trajectory of the vehicle based on yaw rate and steering position further enhances its predictive capabilities, ensuring robust threat detection and mitigation.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or U.S. Pat. No. 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The equipped vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587, 186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a plurality of sensors disposed at a vehicle equipped with the vehicular driving assist system, wherein the plurality of sensors sense exterior of the equipped vehicle, and wherein individual sensors of the plurality of sensors are operable to capture sensor data;
an electronic control unit (ECU) comprising electronic circuitry and associated software;
wherein sensor data captured by the individual sensors of the plurality of sensors is transferred to the ECU;
wherein the electronic circuitry of the ECU comprises a data processor, and wherein the data processor is operable to process sensor data captured by the individual sensors of the plurality of sensors and transferred to the ECU;
wherein the vehicular driving assist system, via processing at the ECU of captured sensor data, is operable to detect presence of an object exterior of the equipped vehicle;
wherein the vehicular driving assist system determines a current overlap between the detected object and a predicted path of travel of the equipped vehicle based at least in part on a current position of the detected object;
wherein the vehicular driving assist system determines a predicted overlap between a predicted position of the detected object and the predicted path of travel of the equipped vehicle based at least in part on a lateral velocity of the detected object; and
wherein the vehicular driving assist system determines that the detected object is a threat based at least in part on (i) the determined current overlap between the detected object and the predicted path of travel of the equipped vehicle and (ii) the predicted overlap between the detected object and the predicted path of travel of the equipped vehicle.

2. The vehicular driving assist system of claim 1, wherein the vehicular driving assist system, responsive to determining that the detected object is a threat, at least in part controls braking of the equipped vehicle.

3. The vehicular driving assist system of claim 1, wherein the vehicular driving assist system determines that the detected object is a threat based at least in part on instantaneously monitored sensor data and predicted trajectory data.

4. The vehicular driving assist system of claim 3, wherein the predicted trajectory data is based at least in part on a yaw rate of the equipped vehicle.

5. The vehicular driving assist system of claim 3, wherein the predicted trajectory data is based at least in part on a steering position of a steering system of the equipped vehicle.

6. The vehicular driving assist system of claim 1, wherein (i) the determined current overlap between the detected object and the predicted path of travel of the equipped vehicle and (ii) the predicted overlap between the detected object and the predicted path of travel of the equipped vehicle are determined based at least in part on a time to collision of the equipped vehicle with the detected object.

7. The vehicular driving assist system of claim 1, wherein the vehicular driving assist system, based on instantaneously monitored sensor data, determines a first time to collision of the equipped vehicle with the detected object, and wherein the vehicular driving assist system, based on predicted trajectory data, determines a second time to collision of the equipped vehicle with the detected object, and wherein the vehicular driving assist system determines that the detected object is a threat based at least in part on at least one selected from the group consisting of (i) the first time to collision and (ii) the second time to collision.

8. The vehicular driving assist system of claim 1, wherein the vehicular driving assist system determines an overlap score for each respective detected object of a plurality of detected objects based at least in part on (i) the determined current overlap between the respective detected object and the predicted path of travel of the equipped vehicle and (ii) the predicted overlap between the respective detected object and the predicted path of travel of the equipped vehicle, and wherein the vehicular driving assist system filters the plurality of detected objects based on the determined overlap scores.

9. The vehicular driving assist system of claim 8, wherein the vehicular driving assist system determines that at least one detected object of the plurality of detected objects is not a threat based at least in part on the determined overlap scores.

10. The vehicular driving assist system of claim 8, wherein the vehicular driving assist system prioritizes a threat level of each detected object of the plurality of detected objects based at least in part on the determined overlap scores.

11. The vehicular driving assist system of claim 1, wherein the vehicular driving assist system determines whether the detected object is a vulnerable road user, and wherein the vehicular driving assist system determines an overlap score for the detected object based at least in part on (i) the determined current overlap between the detected object and the predicted path of travel of the equipped vehicle, (ii) the predicted overlap between the detected object and the predicted path of travel of the equipped vehicle and (iii) whether the detected object is a vulnerable road user.

12. The vehicular driving assist system of claim 1, wherein the plurality of sensors comprises a forward-viewing camera and a forward-sensing radar sensor.

13. The vehicular driving assist system of claim 12, wherein the forward-viewing camera is disposed at an in-cabin side of a windshield of the equipped vehicle and views forward of the equipped vehicle through the windshield.

14. The vehicular driving assist system of claim 1, wherein the vehicular driving assist system, responsive to detecting the presence of the object, determines overlap between the detected object and a lane along which the equipped vehicle is traveling, and wherein the vehicular driving assist system determines an overlap score for the detected object based at least in part on the determined overlap between the detected object and the lane along which the equipped vehicle is traveling.

15. A vehicular driving assist system, the vehicular driving assist system comprising:
a plurality of sensors disposed at a vehicle equipped with the vehicular driving assist system, wherein the plurality of sensors sense exterior of the equipped vehicle, and wherein individual sensors of the plurality of sensors are operable to capture sensor data;
an electronic control unit (ECU) comprising electronic circuitry and associated software;
wherein sensor data captured by the individual sensors of the plurality of sensors is transferred to the ECU;
wherein the electronic circuitry of the ECU comprises a data processor, and wherein the data processor is operable to process sensor data captured by the individual sensors of the plurality of sensors and transferred to the ECU;
wherein the vehicular driving assist system, via processing at the ECU of captured sensor data, is operable to detect presence of a plurality of objects exterior of the equipped vehicle;
wherein the vehicular driving assist system determines whether each respective detected object of the plurality of detected objects is a vulnerable road user;
wherein the vehicular driving assist system, for each respective detected object of the plurality of detected objects, determines a current overlap between the respective detected object and a predicted path of travel of the equipped vehicle based at least in part on a current position of the respective detected object;
wherein the vehicular driving assist system, for each respective detected object of the plurality of detected objects, determines a predicted overlap between a predicted position of the respective detected object and the predicted path of travel of the equipped vehicle based at least in part on a lateral velocity of the respective detected object;
wherein the vehicular driving assist system determines an overlap score for each respective detected object of the plurality of detected objects based at least in part on (i) the determined current overlap between the respective detected object and the predicted path of travel of the equipped vehicle, (ii) the predicted overlap between the respective detected object and the predicted path of travel of the equipped vehicle and (iii) whether the respective detected object is a vulnerable road user; and
wherein the vehicular driving assist system filters the plurality of detected objects based on the determined overlap scores.

16. The vehicular driving assist system of claim 15, wherein the vehicular driving assist system determines that at least one detected object of the plurality of detected objects is not a threat based at least in part on the determined overlap scores.

17. The vehicular driving assist system of claim 15, wherein the vehicular driving assist system prioritizes a threat level of each detected object of the plurality of detected objects based at least in part on the determined overlap scores.

18. A vehicular driving assist system, the vehicular driving assist system comprising:
a plurality of sensors disposed at a vehicle equipped with the vehicular driving assist system, wherein the plurality of sensors comprises a forward-viewing camera and a forward-sensing radar sensor, and wherein the plurality of sensors sense exterior of the equipped vehicle, and wherein individual sensors of the plurality of sensors are operable to capture sensor data;
an electronic control unit (ECU) comprising electronic circuitry and associated software;
wherein sensor data captured by the individual sensors of the plurality of sensors is transferred to the ECU;
wherein the electronic circuitry of the ECU comprises a data processor, and wherein the data processor is operable to process sensor data captured by the individual sensors of the plurality of sensors and transferred to the ECU;
wherein the vehicular driving assist system, via processing at the ECU of captured sensor data, is operable to detect presence of an object exterior of the equipped vehicle;
wherein the vehicular driving assist system, responsive to detecting the presence of the object, determines overlap between the detected object and a lane along which the equipped vehicle is traveling;
wherein the vehicular driving assist system determines a current overlap between the detected object and a predicted path of travel of the equipped vehicle based at least in part on a current position of the detected object;
wherein the vehicular driving assist system determines a predicted overlap between a predicted position of the detected object and the predicted path of travel of the equipped vehicle based at least in part on a lateral velocity of the detected object; and
wherein the vehicular driving assist system determines that the detected object is a threat based at least in part on (i) the determined current overlap between the detected object and the predicted path of travel of the equipped vehicle, (ii) the predicted overlap between the detected object and the predicted path of travel of the equipped vehicle and (iii) the determined overlap between the detected object and the lane along which the equipped vehicle is traveling.

19. The vehicular driving assist system of claim 18, wherein the vehicular driving assist system, responsive to determining that the detected object is a threat, at least in part controls braking of the equipped vehicle.

20. The vehicular driving assist system of claim 18, wherein the vehicular driving assist system determines whether the detected object is a vulnerable road user, and wherein the vehicular driving assist system determines and overlap score for the detected object based at least in part on (i) the determined current overlap between the detected object and the predicted path of travel of the equipped vehicle, (ii) the predicted overlap between the detected object and the predicted path of travel of the equipped vehicle, (iii) the determined overlap between the detected object and the lane along which the equipped vehicle is traveling, and (iv) whether the detected object is a vulnerable road user.
